(19) United States
(12) Patent Application Publication
(10) Pub. No.: US 2007/0217399 A1
(43) Pub. Date: Sep. 20, 2007

(54) Hotline implementation using session initiation protocol legacy telephones

(76) Inventors: Gigo K. Joseph, Arlington Heights, IL (US); Jeffrey C. Wise, Palatine, IL (US)

Correspondence Address: PERRY HOFFMAN & ASSOCIATES P.C., PO BOX 1649, DEERFIELD, IL, 60015, US

(21) Appl. No.: 11/375,790

(22) Filed: Mar. 15, 2006

(51) Int. Cl. H04L 12/66

(52) U.S. Cl. 370/356

(57) ABSTRACT

A telephone network that utilizes the Internet (or a comparable network) to interconnect several VoIP-style phones and at least one operator's phone and that enables one or more of the VoIP-style phones to operate as courtesy phones which are connected through automatically to an operator's phone whenever a courtesy phone go off hook. Data values are maintained that indicate which of the one or more of the several VoIP-style phones are courtesy phones. These indicated courtesy phones are prevented from ringing audibly. INVITE requests are sent across the Internet (or comparable network) to each indicated courtesy phone—these are the type of INVITE requests that normally cause a phone to ring in response to incoming calls, even though in this case there are no incoming calls. When any given indicated courtesy phone returns across the Internet or comparable network a reply to such an INVITE request indicating the given courtesy phone has been taken off hook, a two-way voice communications message channel across the Internet (or comparable network) is established between the given indicated courtesy phone and the operator's phone.

### BACKGROUND OF THE INVENTION

1. Field of the Invention

The present invention relates generally to digital telephony over packet networks such as the Internet and, more particularly, to the implementation of hotline or “courtesy” or “emergency” telephones in airports, elevators, etc. using standard SIP (Session Initiation Protocol) telephones and the like.

2. Description of the Prior Art

Hotline, “courtesy,” and “emergency” telephones are telephones that automatically dial or that are automatically connected through to a predetermined number whenever an individual initiates a hotline call by picking up a telephone's handset or, in the case of an elevator hotline telephone or the like, by actuating an “Emergency Call” button or lever or the like. Hotline telephones are to be found in many airports and train stations as well as in elevators, at the entrances to apartment houses, and at outdoor locations where police, fire or ambulance services may be needed.

Such a telephone may contain a predetermined number in an internal memory, and the telephone may be programmed to auto-dial this number whenever an individual initiates a hotline call. However, such pre-programmed telephones are difficult to reprogram when the telephone number of a hotline service changes, since every telephone must be individually re-programmed. And power failures and the like can cause such telephones to “forget” the number that they were supposed to dial. Hence, it is preferable that the hotline telephones be ordinary telephones and that any programming be contained in a switch or central computer or server. This has the additional advantage that a wide variety of ordinary telephones may then be used as hotline telephones—they do not have to be uniform in design or have special features.

FIG. 1 depicts a conventional airport courtesy phone system 100 where the illustrative airport courtesy phone 102 is a conventional analog telephone connected by a twisted wire pair 103 to an airport private branch exchange (or PBX) digital switch 104. An airport telephone operator's phone 106 is also connected to the same PBX switch 104 by another twisted wire pair 105. When the phone 102 goes “off hook” (at 110), a current flow 112 through the twisted wire pair 103 signals the switch 104 which is programmed to respond by dialing and ringing the operator's phone 106. When the operator answers the phone 106 (“off hook” at 120), the switch 104 conveys voice signals (126-128-130) between the twisted wire pairs 103 and 105 and thereby completes the call. Accordingly, the users of the airport courtesy phone 102 do not need to dial a number, and the phone 102 also does not have to be designed to automatically dial a number whenever a user takes it “off hook.” Call detection and placement is handled automatically by programming within the switch 104. This is a satisfactory arrangement, but it does not take full advantage of modern Internet technology.

FIG. 2 presents another conventional system 200 that utilizes the same conventional phones 102 and 106 and their twisted wire pairs 103 and 105 introduced in FIG. 1. In FIG. 2, however, the twisted wire pairs do not connect to a central PBX switch. Instead, calls are routed across the Internet 207 (or a comparable Internet-like private network). The twisted wire pairs 103 and 105 (labeled “POTS”—“plain old telephone system”—in FIG. 2) connect the conventional phones 102 and 106 each to its own customer premises equipment 203 and 205, as shown, and the customer premises equipment 203 and 205 connect to the Internet 207. As a substitute for the PBX switch 104 shown in FIG. 1, in FIG. 2 a media gateway controller or MGC 218 connects to the Internet 207 and receives an OFF HOOK command 230 when the phone 102 goes “off hook” (at 110). The MGC 218 is programmed to respond to this OFF HOOK command 230 by setting up a “hot line” call. It exchanges the media gateway control protocol (MGCP) commands 230, . . . , 238 with the customer premises equipment 203 and 205. These commands travel across the Internet 207 along the symbolic Internet paths 211 and 213 to the equipment 203 and 205. After a call is established, voice signals 126 and 130 received from the phones 102 and 106 are digitized and compressed by the equipment 203 and 205 and are sent across the Internet 207 along the symbolic path 209 in the form of Internet datagrams 240 formatted in accordance with a real-time transfer protocol (RTP), as is indicated in FIG. 2. Because the customer premises equipment 203 and 205 simply translate each signal received from the phones 102 and 106 into equivalent MGC protocol commands that are sent to the MGC 218 and vice versa, the MGC 218 can be programmed to respond to an incoming MGCP OFF HOOK command 230, generated when the airport courtesy phone 102 goes “off hook” (at 110), by establishing a call to the airport operator's phone 106 without the user of the courtesy phone 102, or the phone 102 itself, having to dial any number. This is also a satisfactory arrangement. But this particular Internet telephony arrangement does not support the use of so-called VoIP phones—phones that connect directly to the Internet—as will now be explained.

In FIG. 3, a pair of “voice over Internet” protocol (VoIP) phones 302 and 306 are substituted for the conventional analog telephones 102 and 106. In FIG. 3, the Internet 207 connects the VoIP airport courtesy phone 302 directly to the VoIP airport operator's phone 306—no POTS (plain old telephone system) analog signals 103 and 105 are required in this arrangement. (Thus, the customer premises equipment 203 and 205 shown in FIG. 2 is not needed in FIG. 3 to interface the phones 302 and 306 with the Internet 207.) Once a call has been established, the two VoIP phones 302 and 306 exchange compressed or uncompressed voice information over the Internet 207 along the symbolic path 209 through the Internet. The voice information takes the form of Internet datagrams that are formatted in accordance with a real-time transfer protocol (RTP), just as was the case in FIG. 2.

To establish a call, the VoIP phones 102 and 106 do not use the media gateway control protocol (MGCP), since there are no POTS analog commands that need to be translated and sent across the Internet 207. Instead, a newer and more efficient Session Initiation Protocol or “SIP”—set forth in an RFC 3261 (the Internet Society, June 2002-replacing earlier RFC 2543 dated March 1999)—is used to establish each call. A SIP proxy and registrar server 318 exchanges SIP requests and responses 332, . . . , 342 (which travel across the Internet 207 along the symbolic SIP Internet paths 311 and 313) with the two VoIP phones 302 and 306 to establish a call, as is shown in the timing diagram presented in the lower half of FIG. 2 (and as will be explained more fully below).

The conventional VoIP phone 302 shown in FIG. 3 works differently than does the conventional analog telephone 102 shown in FIGS. 1 and 2. No request is sent out by the VoIP phone 302 until after the user has both taken the courtesy phone “off hook” and also dialed a number. Once a number has been dialed (DIAL# at 330), the phone 302 generates a SIP protocol INVITE request 332 that flows over the symbolic SIP Internet path 311 to a SIP proxy and registrar server 318. The SIP proxy and registrar server 318 then sets up a call connecting the courtesy phone 302 to the operator's phone 306 using more SIP requests and responses 334, . . . , 342 (as will be explained below).

Accordingly, when the VoIP phone 302 is used as a courtesy phone, the user must dial a number—or alternatively the phone 302 must itself be programmed to auto-dial a number—whenever it goes “off-hook.” But either of these arrangements is undesirable for the reasons listed above.

Accordingly, a general object of the present invention is to enable an ordinary SIP based VoIP phone or SIP based customer provided equipment or the like, without any special programming of the phone itself, to be used as an airport or other type of courtesy phone in a system that establishes a call from the courtesy phone to an operator's phone whenever the VoIP phone is taken “off hook” without the need for the dialing of any number or for any other equivalent action or command sequence to be executed by the VoIP courtesy phone.

### SUMMARY OF THE INVENTION

Briefly described, the present invention, in one embodiment, can be realized in a telephone network that utilizes the Internet or a comparable network to interconnect several VoIP-style phones and at least one operator's phone. This method enables one or more of the VoIP-style phones to operate as courtesy phones which are connected through automatically to an operator's phone whenever a courtesy phone go off hook. This method comprises the following steps: maintaining data values indicating which one or more of the several VoIP-style phones are courtesy phones; preventing the indicated courtesy phones from ringing audibly; sending across the Internet or comparable network to each indicated courtesy phone at least one INVITE request of the type normally used to cause those phones to ring in response to incoming calls, even though there are no incoming calls; and when any given indicated courtesy phone returns across the Internet or comparable network a reply to such an INVITE request indicating the given courtesy phone has been taken off hook, establishing a two-way voice communications message channel across the Internet or comparable network between the given indicated courtesy phone and the operator's phone.

### BRIEF DESCRIPTION OF THE DRAWINGS

FIG. 1 presents a block diagram of a conventional airport analog PBX courtesy phone system in its upper half and a timing diagram illustrating the flow of commands between the elements of the phone system in its lower half.

FIG. 2 presents a block diagram of a conventional airport courtesy phone system implemented using conventional analog phones interfaced to the Internet and to a media gateway controller by means of customer premises equipment in its upper half and a timing diagram illustrating the flow of commands between the elements of the phone system in its lower half.

FIG. 3 presents a block diagram illustrating an attempt to realize an airport courtesy phone system using conventional VoIP phones connected to each other and to a proxy and registrar server by means of the Internet in its upper half and a timing diagram illustrating the flow of requests and responses between the elements of the phone system in its lower half.

FIG. 4 presents a block diagram illustrating a first embodiment of an improved airport courtesy phone system constructed using VoIP phones connected to each other and to a proxy and registrar server by means of the Internet in its upper half and a timing diagram illustrating the flow of requests and responses between the elements of the phone system in its lower half.

FIG. 5 presents a block diagram illustrating a second embodiment of an improved airport courtesy phone system constructed using a mixture of VoIP phones and conventional phones in its upper half and a timing diagram illustrating the flow of requests, responses, and commands between elements of the phone system in its lower half.

FIG. 6 presents a block diagram revealing the details of the media gateway and controller shown in FIG. 5.

FIG. 7 is a table illustrating the contents of a subscriber location register modified to distinguish courtesy phones from other types of phones.

### DETAILED DESCRIPTION OF THE EMBODIMENTS

General Introduction

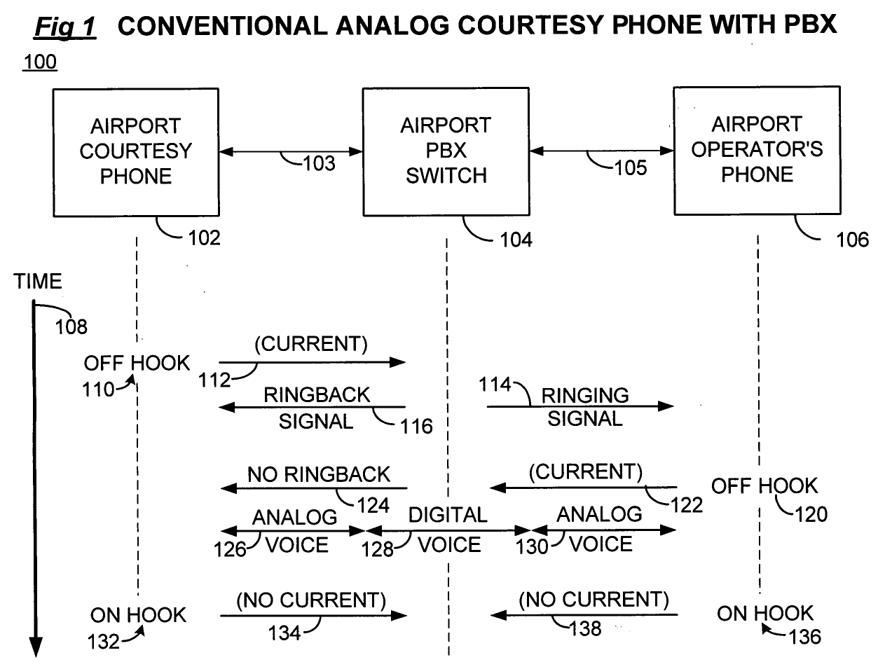

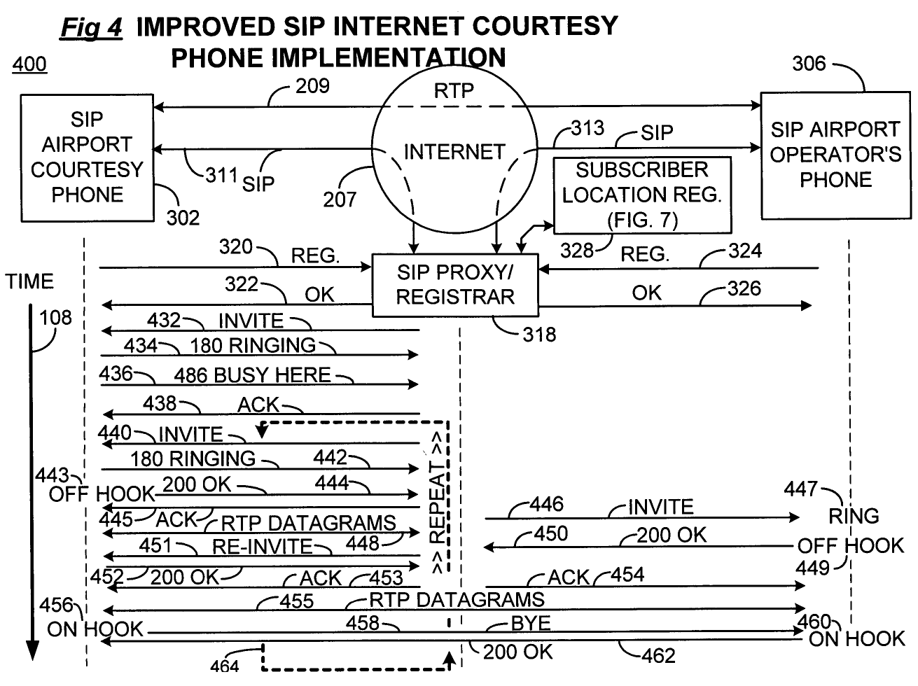

This first section introduces telecommunications technology as it relates to courtesy phones. This section makes reference to FIGS. 1 through 3 that were also discussed briefly in the “DESCRIPTION OF THE PRIOR ART” section presented above. The two sections which follow describe embodiments of the present invention and make reference to FIGS. 4 through 7.

FIG. 1 illustrates the operation of a courtesy phone system 100 that utilizes a conventional, analog airport courtesy telephone 102 in conjunction with an airport PBX, or private branch exchange, digital switch 104. A conventional analog telephone, labeled “airport courtesy phone” 102, is shown connected by a conventional twisted-wire pair 103 to the airport's PBX switch 104. The switch, in turn, is connected by other twisted wire pairs to many additional telephones (not shown), and in particular is connected by a twisted wire pair 105 to at least one airport operator's phone 106.

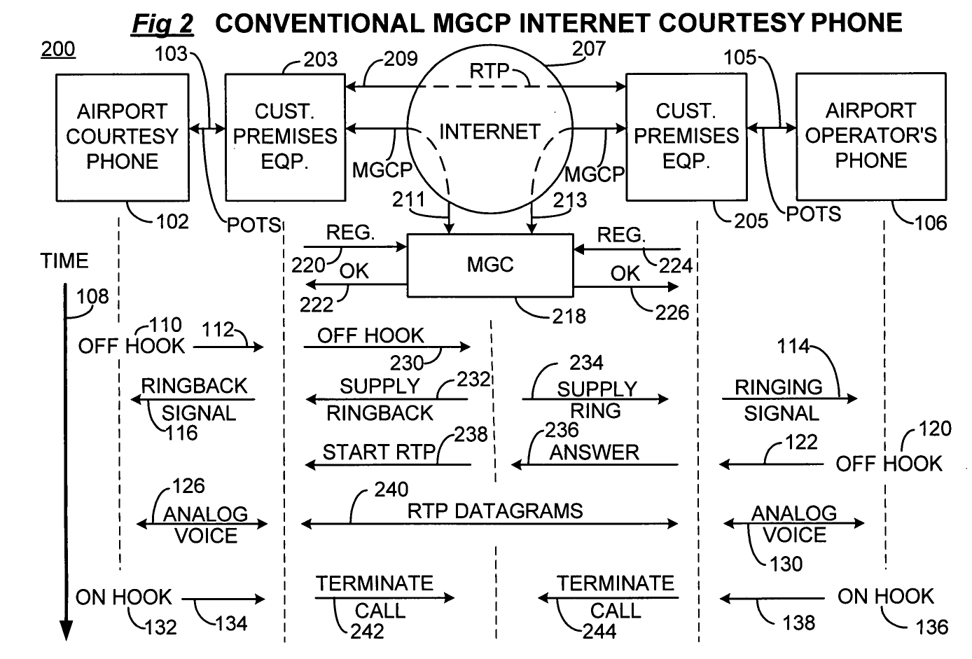

Below the elements 102, 104, and 106 in FIG. 1 a timeline 108 is shown with time increasing in the downwards direction. (This same layout is followed in FIGS. 2 to 5.) When an individual initiates a call on the courtesy phone 102, the individual picks up the phone's handset (not shown), and the phone then 102 goes “OFF HOOK” as shown at 110. The phone 102 permits a current 112 to flow over the twisted wire pair 103, and thus the phone 102 signals the switch 104 that the telephone 102 is OFF HOOK.

The switch 104 is programmed to respond to this OFF HOOK condition by sending a low-frequency, audible ringing signal 114 to the operator's phone 106. This causes the phone 106 to ring. Meanwhile, the PBX switch transmits a ringback signal 116 to the courtesy phone 102—the musical signal heard on any telephone by a caller while the telephone is ringing a called party.

The airport operator answers the operator's phone 106 by picking up the phone's handset (not shown), and this causes the phone 106 to go OFF HOOK 120 and to transmit a current 122 over the twisted wire pair 105 to signal the switch 104 that the telephone 106 is now OFF HOOK. The PBX switch 104 then terminates both the ringing signal 114 and the ringback signal 116 (as indicated at 124) and initiates voice communication between the courtesy phone 102 and the operator's phone 106. Analog voice signals 126 and 130 flow between the two phones 102 and 106 and the PBX switch 104. The switch 104 digitizes the incoming analog voice signals flowing into the switch 104 from the twisted wire pairs 103 and 105, transfers digital voice signals 128 in both directions through the switch 104, transforms these digital voice signals back into analog voice signals, and sends the analog voice signals back across the twisted wire pairs 103 and 105 to the courtesy telephone 102 and the operator's telephone 106, thus establishing voice communication between the two phones 102 and 106.

Voice communication continues until one or both of the handsets of the phones 102 and 106 are returned to their cradles, at which time the phones 102 and 106 go “ON HOOK” (132 and 136) and signal the PBX switch 104 by halting the flow of current over the twisted wire pairs 103 and 105 (reestablishing the no current condition, as shown at 134 and 138). Then the system 100 just described remains quiescent, awaiting the next courtesy call.

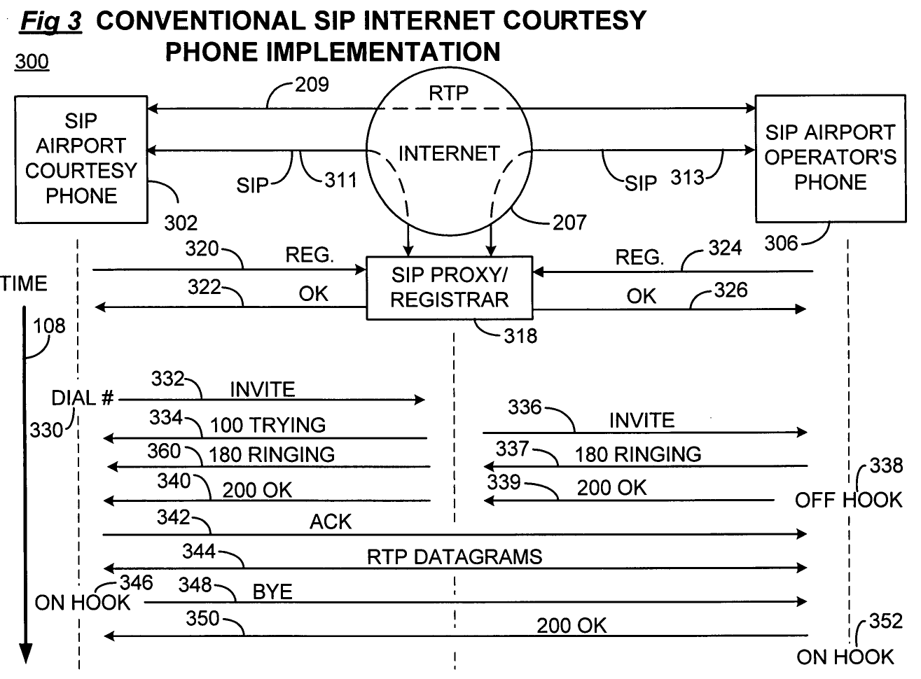

Today, the trend in telephone systems is away from traditional analog telephones 102 and 106 that communicate over twisted wire pairs 103 and 105 through a digital central office or PBX switch 104, as illustrated in FIG. 1. With reference to FIG. 3, the modern trend is towards the use of all-digital VoIP (Voice over IP) telephones 302 and 306 that communicate over the Internet 207 directly with each other, as indicated by the symbolic Internet data flow line labeled RTP 209 in FIG. 3. RTP is a protocol that governs most such Internet telephony—the “Real-time Transport Protocol” set forth in RFC 3550 (the Internet Society, July 2003—replacing an earlier RFC 1889 dated January 1996). Using the RTP protocol, the two VoIP phones 302 and 306 exchange IP Datagrams containing digitized and compressed or uncompressed voice information and constructed in accordance with the User Datagram Protocol UDP/IP set forth in RFC 768 (the Internet Society, August 1980).

The RTP protocol defines only how any two VoIP telephones 302 and 306 communicate after a call has been established. Other protocols are used to set up the call initially. Two such protocols are illustrated respectively in FIG. 2 and in FIG. 3.

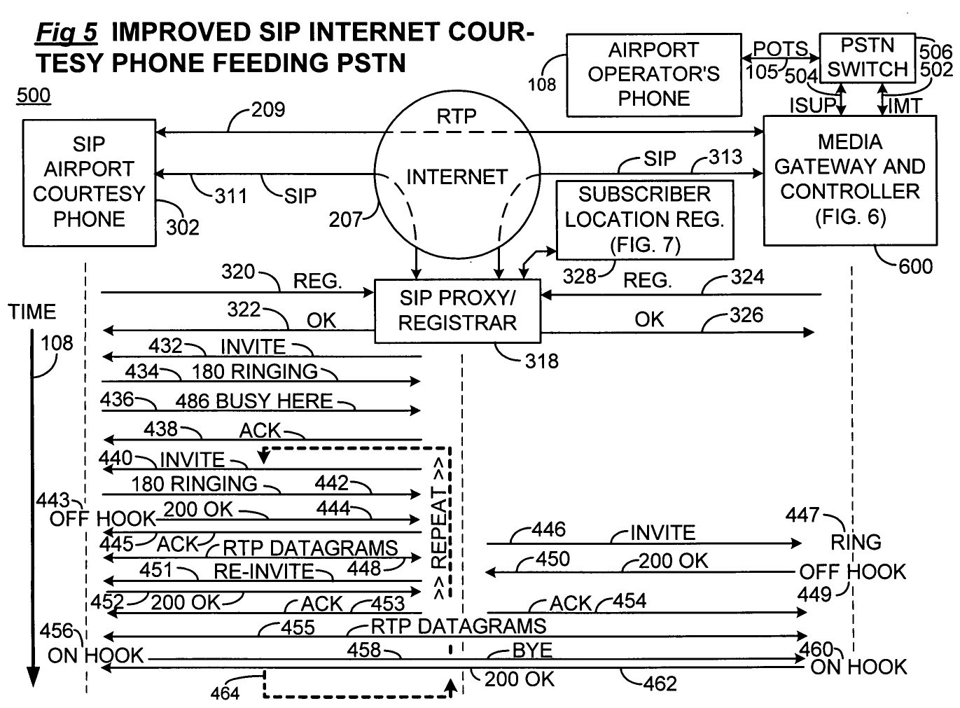

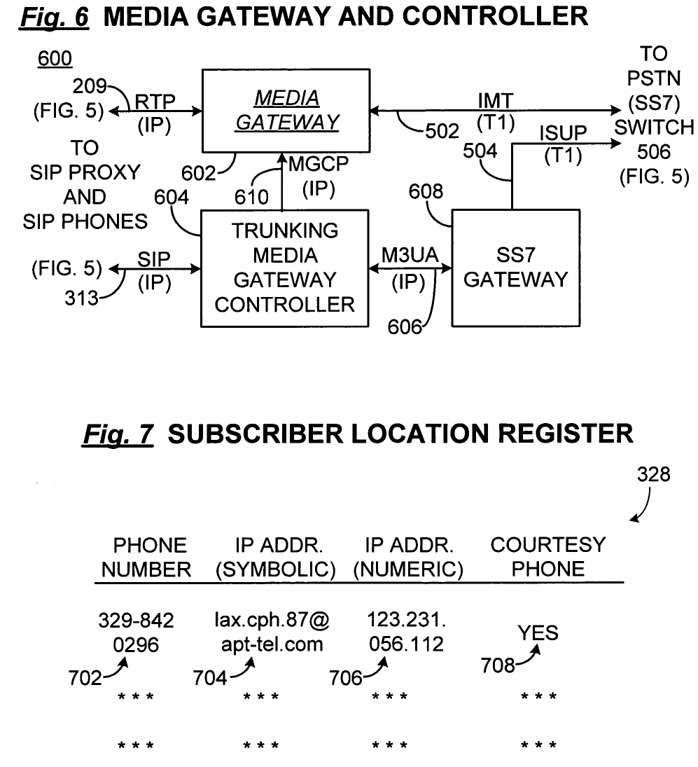

In FIG. 3, two VoIP phones 302 and 306, and assumedly additional phones (not shown), utilize what is called the Session Initiation Protocol, or SIP, to set up and establish calls across the Internet 207. To assist the phones 302, 306, etc., in establishing calls, the SIP protocol calls for the use of one or more proxy servers and also one or more registrar servers which cooperate to set up calls between phones. To simplify the discussion which follows, FIG. 3 (and FIGS. 4 and 5) shows only one illustrative server 318 which is both a SIP proxy server and a SIP registrar server. The server 318 (in FIGS. 4 and 5 but not in FIG. 3) contains a subscriber location register 328 the contents of which are shown in FIG. 7. The phones 302 and 306, when placed into service, first send REGISTRATION requests 320 and 324 across the Internet 207 along the symbolic Internet paths 311 and 313 (marked “SIP” in FIG. 3) to the SIP proxy and registrar server 318. These requests contain the phone number 702 and internet address 704 and 706 of each phone which are recorded in the subscriber location register 328 along with other pertinent information (as will be explained). The VoIP phone 302, in response to someone lifting its handset and dialing the telephone number of the phone 306, requests that a call be set up to the phone 306. It does so by sending a SIP INVITE request (shown at 332) to the SIP proxy and registrar server 318 over the symbolic Internet request path 311. The proxy server 315 forwards the INVITE request (shown now at 336) to the phone 306 over the symbolic path 313. This request may have to be forwarded through several proxy servers until one is found that has access to a subscriber location register 328 containing the registered number and internet address of the phone 306.

The phone 306 normally responds to the request 336 by ringing (if it is not otherwise busy or disabled), and it sends a 180 RINGING response signal 337 back to the proxy and registrar server 318 over the Internet 207 path 313. The proxy and registrar server 318 relays the 180 RINGING response signal (now shown at 360) back to the phone 302. When the phone 306 is answered, the phone 306 sends a 200 OK response 339 back to the server 318, and this response is relayed by the server 318 back to the phone 302 as a 200 OK response 340. The phone 302 responds by sending an ACK response 342 back directly to the phone 306, bypassing the server 318. The two phones 302 and 306 from this point onwards then exchange RTP DATAGTAMS 344 until the phone 302 goes ON HOOK at 346, at which point the phone 302 sends a BYE request 348 to the phone 306 which responds with a 200 OK response 350 and then goes ON HOOK at 352. Either phone may go ON HOOK first and can send out the BYE request that terminates the connection.

The SIP protocol, just described in brief overview, is used to set up a call between the two phones 302 and 306 when both phones are VoIP phones that connect directly to the Internet 207. It is used in both embodiments of the invention described below.

FIG. 2 illustrates the use of an alternative protocol, called the media gateway control protocol or MGCP. The Media Gateway Control Protocol MGCP, is set forth in RFC 2705 (the Internet Society—October 1999). This protocol plays a small role in the second embodiment of the invention, as will be explained in conjunction with FIG. 7. Generally speaking, the MGCP protocol calls for the conventional analog telephone signaling events generated by the phones 102 and 106 and illustrated in FIG. 1 to be simply translated by special customer premises equipment 203 and 205 into MGCP commands which are digital and which can flow across the Internet to a media gateway controller 218 over the symbolic paths labeled 211 and 213 in FIG. 2. (In FIG. 7, MGCP commands flow between the trunking media gateway controller 604 and the media gateway 602 over a path 610 which is a symbolic path across the Internet 207.)

In FIG. 2, very briefly summarized, the two conventional phones 102 and 106 (introduced in FIG. 1) are shown communicating a short distance over their respective twisted wire pairs 103 and 105 (labeled “POTS” in FIG. 3—POTS being the abbreviation for “plain old telephone system.”) with respective special phone-to-Internet interfacing customer premises equipment 203 and 205. The equipment 203 and 205 connect directly to the Internet 207 and exchange voice-conveying IP Datagrams across the Internet over the symbolic path 209, which is labeled RTP, just as was explained above in connection with FIG. 3.

To initialize this system 200, the equipment 203 and 205 when first turned on send MGCP registration requests REG 220 and 224 to the MGC 218 to register each phone's telephone number and Internet address. The MGC 218 responds by sending back MGCP OK responses 222 and 226.

The two phones 102 and 106 thereafter communicate with the equipment 203 and 205 in FIG. 2 in the same way that they communicated with the PBX switch 104 in FIG. 1. The equipment 203 simply translates incoming POTS signals 112 and 122 (OFF HOOK), and 134 and 138 (ON HOOK) received from the phones 102 and 106 (and fully described in FIG. 1) into the respective corresponding MGCP protocol signals 230 (OFF HOOK), 236 (ANSWER), 242 and 244 (TERMINATE CALL); and these are passed across the Internet 207 over the symbolic paths 211 and 213 (labeled MGCP) to the MGC 218. Outgoing MGCP signals sent out by the MGC 218 include the signals 232 (SUPPLY RINGBACK), 234 (SUPPLY RING), and 238 (START RTP) the first two of which the customer premises equipment translates into the POTS ringback 116 and ringing 114 signals which sent to the phones 102 and 106, as shown in FIG. 2; and the last of which triggers the flow of voice message conveying RTP datagrams 240.

Description of an Embodiment of the Invention

A first embodiment of the invention is set forth in FIG. 4. As in FIG. 3, a SIP VoIP airport courtesy phone 302 is interconnected by the Internet 207 to other phones, including a SIP VoIP airport operator's phone 306; and calls are established by the same SIP proxy and registrar server 318 arrangement that was introduced in FIG. 3. The server 318 (or some other accessible server) contains a subscriber location register 328. With reference to FIG. 7, each data entry in this register 328 contains a telephone number 702 that is assigned to a phone, in this case to the airport courtesy phone 302. This data entry also contains the IP address which appears at 704 (in symbolic form) and again at 706 (in numeric form) of the phone 302 as well as other information (not shown) concerning the phone 302 and relevant to placing a call to or from the phone 302. For example, the UDP port through which the phone 302 receives RTP datagrams is normally specified (or a default value is assumed).

In accordance with an aspect of the present invention, the subscriber location register shown in FIG. 7 is modified so that it contains a data value 708 indicating whether the phone 302 is, or is not, a courtesy phone. Since the phone 302 is an airport courtesy phone, the data value 328 is set to “YES;” if the phone 302 were not an airport courtesy phone, the data value 708 would be set to “NO.” In another embodiment, this data value could be set to “1” or to “0;” or it could be recorded in some other equivalent fashion or in some other place, possibly in a separate table, register, or database. However it is recorded, this data value enables the SIP proxy and registrar server 318 to identify all the courtesy phones managed by the server 318 and to treat them differently than it treats other non-courtesy phones, as will be explained.

The two VoIP phones 302 and 306, when first placed in service, send registration requests 320 and 324 to the SIP proxy and registrar server 318. In response, the server 318 responds with OK responses 322 and 326 and registers the phone numbers, Internet addresses, and other pertinent information concerning these two phones in the subscriber location register 328. In the case of the register entry for the airport courtesy phone 302, an administrator also sets the data value 708 to “YES.” The installer of the airport courtesy phone 302 adjusts the phone 302 so that its ringer is disabled—no one will hear it ringing. (This can be done by setting up the phone 302 software either with the ringer disabled or with the ringer volume set to zero; or alternatively, the ringer speaker may be disconnected from the phone 302's speaker leads or removed entirely or disabled by means of a speaker switch. Other speaker disabling arrangements may also be used.)

In accordance with the invention, the SIP proxy and registrar server 318 detects all of the entries in the subscriber location register 328 for courtesy phones which contain a “YES” value assigned to the data value 708. The server 318 is programmed to automatically send SIP INVITE requests 432 to the courtesy phone 302 and to all other phones thus identified as courtesy phones. The phone 302 and all the other courtesy phones normally respond with a 180 RINGING response at 434, thus signaling that the phone 302 and the other courtesy phones have commenced ringing in response to these requests; but since these phone's ringers have all been disabled, the phones do not produce an audible ringing sound. The server 318 does not respond to incoming 180 RINGING responses. If such a phone happens to be in use when it receives such an INVITE request, the phone responds instead with a SIP 486 BUSY HERE 436 response, and the server 318 replies to this with an ACK reply 438 to acknowledge that the phone is busy. But the server 318 is programmed to send out another INVITE request 440 to such a busy courtesy phone after a short time delay. In this manner, the server 318 continues to send out periodic INVITE requests 432 or 440 as needed to keep the courtesy phones ringing and to cause any busy courtesy phone to commence ringing as soon as it is no longer busy.

Next the SIP proxy and registrar server 318 and the courtesy phone 302 (as well as all other similarly configured, active courtesy phones) enter a repetitive dialogue 464 of requests and responses, as is shown in the lower part of the timing diagram 108 in FIG. 4 (also shown in FIG. 5, described below), and which will now be described:

A series of one or more INVITE requests 440 issued by the server 318 cause the airport courtesy phone 302 to ring silently, since its speaker has been disabled. When an airport patron picks up the handset of the phone 302, the phone 302 goes OFF HOOK 403 and sends a 200 OK reply 444 back to the SIP registrar and proxy server 318. The server 318 promptly sends an acknowledgment response ACK 445 back to the phone 302 and then enters into a dialogue with the phone 302, as is indicated by the exchange of RTP datagrams 448 shown in FIG. 4. These datagrams convey an audio message from the server 318 to the phone 302. The message may simply be a so-called ringback signal, an audio message that sounds to the airport patron just like a ringing signal on a standard telephone. Alternatively, the message may be a voice message, such as: “Airport Service Center. All operators are busy now. Your call will be transferred to the next available operator. Please wait,” followed by background music or the like.

At about the same time, the SIP proxy and registrar server 318 sends or forwards (through one or more other proxy servers) an INVITE request 446 to the phone 306 of an available airport operator. This causes the operator's phone 306 to ring, as indicated at 447. This operation may involve additional steps if there are multiple operators. One of the proxy servers may have to search through a list of operator's phones searching for one that is in service and not already busy handling a call. If none are available, this proxy server may delay establishing a call to an operator and may also send an appropriate message back to the airport patron in the stream of RTP datagrams 448.

Eventually, the airport operator lifts up the handset of the operator's phone 306, causing it to go OFF HOOK at 449. The phone 306 then sends a 200 OK response 450 back to the server 318.

When the server 318 learns that the airport operator has picked up his or her handset, the server immediately sends out a SIP RE-INVITE request 451 to the airport courtesy phone 302. This stops the exchange of RTP datagrams 448 between the server 318 and the phone 302 without breaking the SIP command connection. The phone 302 responds with a 200 OK response 452.

Now, to establish a direct telephone connection between the two phones 302 and 306, the SIP proxy and registrar server 318 sends out SIP ACK responses 453 and 454 to both the airport courtesy phone 302 and to the airport operator's phone 306. These ACK responses 453 and 454 supply to each of the phones 302 and 306 the IP address as well as the RTP datagram port address of the other phone 306 and 302, thus programming the two phones 302 and 306 to exchange RTP datagrams with each other, and not with the server 318.

Accordingly, the two phones 302 and 306 commence exchanging voice conveying RTP datagrams 455, conveying the voice of the airport patron to the airport operator and conveying the voice of the airport operator to the airport patron. This continues until one or both of the patron and operator hang up, causing the phones 302 and 306 to go ON HOOK as indicated at 456 and 460. The first phone 302 to go ON HOOK 456 sends a BYE request 458 to the other phone 460 which responds with a 200 OK response 462. The next INVITE request 440 sent out by the server 318 to the phone 302 then causes the phone 302 to again ring silently, and this initiates a new cycle of operation.

By this arrangement, any conventional SIP VoIP phone may be used as a courtesy phone without the need to preprogram into the phone any telephone numbers and without the need to instruct the user of the phone to dial any number.

Description of a Second Embodiment of the Invention

In FIG. 5, a system 500 is shown which, like the system 400 shown in FIG. 4, makes use of standard SIP VoIP phones 302 as courtesy phones and which interconnects such phones to a proxy and registrar server 318 by means of the Internet 207. Thus, much of what is shown in FIG. 5 is identical to what is shown in FIG. 4 and needs not be described again at this point.

The difference is that in FIG. 5, the airport operator's phone is a conventional analog or digital phone 108 that generates POTS (plain old telephone system) analog signals 105 and that connects to a conventional PSTN (public switched telephone network) switch 506 of the digital, Signaling System 7 (SS7) variety. In this embodiment, courtesy calls generated using the VoIP phone 302 are routed over the Internet 207 under the management of the SIP proxy and registrar server 318 to a media gateway and controller 600 (the details of which are shown in FIG. 6) and from the controller 600 over one or more digital T1 communication lines (as IMT 502 and ISUP 504 signals—explained below) to the PSTN (SS7) switch 506 which in turn is connected to the airport operator's phone 108 by the POTS analog line 105.

From the perspective of the courtesy phone 302 and the SIP proxy and registrar server 318, the media gateway and controller 600 behaves as if it were just another cluster of VoIP telephones. From the perspective of the operator's phone 108 and the PSTN (SS7) switch 506, the media gateway and controller 600 behaves as if it were just another SS7 switch. The task of the media gateway and controller 600 is thus to transform the SIP protocol signals flowing over the Internet 207 to and from the controller 600 into standard SS7 PSTN protocol signals flowing over a T1 line as ISUP 504 and IMT 502 signals directed to and from the PSTN (SS7) switch 506.

The details of the controller 600 are shown in FIG. 6. SIP protocol requests and responses 313 flowing to and from the SIP proxy and registrar server 318 and the VoIP courtesy phone 302 flow over the Internet 207 and into a trunking media gateway controller 604 that is connected to the Internet 207 and that appears to be another proxy server and/or another registrar server from the perspective of the proxy and registrar server 318. This controller 604 then sends MGCP commands (discussed above—digital MGC Protocol commands that generally correspond to conventional POTS commands) across the Internet 207 over a symbolic Internet path 610 to a media gateway 602. These MGCP commands program the gateway 602 to exchange RTP datagrams 209 directly with the courtesy phone 302. From the perspective of the phone 302, the media gateway 602 appears simply to be just another VoIP phone with which it communicates by exchanging RTP datagrams.

An SS7 gateway 606 is also connected to the Internet 207 and is arranged to exchange M3UA protocol IP datagrams with the trunking media gateway controller 604, over a symbolic Internet path 606, as is shown. The M3UA protocol supports the transport of the SS7 Integrated Service Digital Network User Part (ISUP) signaling across the IP network 207. Hence, the trunking media gateway controller 604, in addition to programming the media gateway 602 to send and to receive voice RTP datagrams to and from the phone 302, also transforms the remaining SIP protocol requests and responses into equivalent sequences of SS7 ISUP signals which are sent to the SS7 gateway 608 across the Internet 207 packed into M3UA datagrams. The controller 604 also transforms returned SS7 user part signaling commands received from the SS7 gateway 608 into sequences of SIP requests or responses which are sent back over the Internet 207 to the proxy and registrar server 318 and sometimes directly to the VoIP courtesy phone 302.

The media gateway 602 and the SS7 gateway 608 are connected by one or more conventional T1 digital telephone signal lines to the PSTN (SS7) switch 506 (shown in FIG. 5). The SIP protocol requests and commands 313, which were translated into SS7 ISUP signals by the trunking media gateway controller 604 and then transferred to the SS7 gateway 608 packed into M3UA datagrams 606, are unpacked by the SS7 gateway 608 and appear as SS7 ISUP signals 504 which flow over one or more T1 signal lines to the PSTN (S7) switch 506. Likewise, the voice-conveying RTP datagrams 209, which flow both ways over the Internet 207 between the media gateway 602 and the phone 302, are transformed into Inter-Machine Trunk (IMT) digitized voice signals 502 which convey voice message data in both directions over a T1 signal line to and from the PSTN (S7) switch 506. Of course, other types of signal lines and protocols can be used to interconnect the PSTN (S7) switch 506 or some other type of switch to the media gateway and controller 600.

The arrangement just described causes the airport operator's phone 108 shown in FIG. 5 to behave in essentially the same manner as the SIP airport operator's phone 306 shown in FIG. 4. If there are multiple airport operator's phones such as the phone 108, the selection of which airport operator's phone a given airport courtesy phone call should be routed to, and what to do if all the operator's phones are busy, can be handled by the SIP proxy and registrar server 318, as described in FIG. 4; or these functions can be handled instead by programming within the PSTN (SS7) switch 506 or by a comparable airport PBX switch, such as the switch 104 shown in FIG. 1, which could be incorporated into FIG. 5 between the PSTN (SS7) switch 506 and the phone 108 to manage multiple airport operator's phones. In such an arrangement, it may even be possible to omit or bypass entirely the switch 506 if the PBX switch is able to accept the ISUP signals 504 and the IMT signals 502 or equivalent signals from a modified form of media gateway and controller 600 that includes a suitable interface to the selected PBX switch.

While several embodiments of the invention have been described, further modifications and changes will occur to those skilled in the art. Accordingly, the claims appended to and forming a part of this specification are intended to cover all such modifications and changes as fall within the true spirit and scope of the invention.

What is claimed is:

1. In a telephone network that utilizes the Internet or a comparable network to interconnect several VoIP-style phones and at least one operator's phone, a method which enables one or more of the VoIP-style phones to operate as courtesy phones which are connected through automatically to an operator's phone whenever a courtesy phone go off hook, the method comprising the steps of:
maintaining data values indicating which one or more of the several VoIP-style phones are courtesy phones;
preventing the indicated courtesy phones from ringing audibly;
sending across the Internet or comparable network to each indicated courtesy phone at least one invite request of the type normally used to cause those phones to ring in response to incoming calls, even though there are no incoming calls; and
when any given indicated courtesy phone returns across the Internet or comparable network a reply to such an invite request indicating the given courtesy phone has been taken off hook, establishing a two-way voice communications message channel across the Internet or comparable network between the given indicated courtesy phone and the operator's phone.

2. A method in accordance with claim 1 further comprising:
following each performance of the establishing step, repeating the sending step and the establishing step.

3. A method in accordance with claim 2 further comprising:
when any given indicated courtesy phone returns across the Internet or comparable network a reply to an invite request indicating the given courtesy phone is busy, repeating the sending step after a time delay.

4. A method in accordance with claim 3 further comprising:
in further response to such a busy reply, sending an acknowledgment back to the given indicated courtesy phone.

5. A method in accordance with claim 1 further comprising:
when any given indicated courtesy phone returns across the Internet or comparable network a reply to an invite request other than a reply indicating the given courtesy phone is ringing or has been taken off hook, sending an acknowledgment back to the given indicated courtesy phone and then repeating the sending step after a time delay.

6. A method in accordance with claim 1 wherein the operator's phone is one of the VoIP-style phones, and wherein the establishment step further comprises:
sending at least one invite request to the operator's phone;
when the operator's phone returns a reply to the invite request indicating the operator's phone has been taken off hook
sending a re-invite request to the given indicated courtesy phone and
after the indicated courtesy phone acknowledges the re-invite request, sending an acknowledgement response to the operator's phone and to the given indicated courtesy phone to establish a two-way exchange of voice carrying messages between the operator's phone and the given indicated courtesy phone

7. A method in accordance with claim 6 wherein the sending an acknowledgment response step comprises including in the acknowledgment replies sent to each of the two phones the internet and port address of the other phone to cause the two phones to thereafter exchange voice carrying messages comprising datagrams containing digitized voice information.

8. A method in accordance with claim 1 wherein the operator's phone is a conventional phone connected to the Internet or a comparable network by a gateway, and where the establishment step further comprises:
sending at least one invite request to the gateway, the request being addressed to the operator's phone;
when the gateway returns a reply to the invite request indicating the operator's phone has been taken off hook
sending a re-invite request to the given indicated courtesy phone and
after the indicated courtesy phone acknowledges the re-invite request, sending acknowledgement responses to the gateway and to the given indicated courtesy phone that together establish a two-way exchange of voice carrying messages between a port on the gateway which the gateway has assigned to the operator's phone and the given indicated courtesy phone.

9. A method in accordance with claim 8 wherein the sending an acknowledgment response step comprises:
including in the acknowledgment response sent to the indicated courtesy phone the address of the port which the gateway has assigned to the operator's phone and including in the acknowledgment response sent to the gateway the address of a port which the indicated courtesy phone has enabled for voice messages to cause the given indicated courtesy phone to thereafter exchange voice carrying messages comprising datagrams containing digitized voice information with the gateway port address assigned to the operator's phone.

10. A telephone system that utilizes the Internet or a comparable network to connect one or more VoIP-style phones and at least one operator's phone wherein one or more of the VoIP-style phones are to operate as courtesy phones which are automatically connected through to an operator's phone when they go off hook, the system comprising:
one or more proxy servers connected to each other and to the one or more VoIP-style phones and operator's phones by the Internet or a comparable network;
data values accessible to the proxy server that indicate which of the one or more VoIP-style phones are courtesy phones;
audible ring suppression means associated with the indicated VoIP courtesy phones for preventing them from ringing audibly;
first program means within the proxy server for causing it to send across the Internet or comparable network to each indicated courtesy phone at least one invite request of the type which would normally be used to cause those phones to ring in response to incoming calls, even though there are no incoming calls; and
second program means within the proxy server and responsive to any given indicated courtesy phone returning across the Internet or comparable network a reply to such an invite request indicating the given indicated courtesy phone has been taken off hook for establishing a two-way voice communications message exchange channel or its equivalent across the Internet or comparable network between the given indicated courtesy phone and the operator's phone.

11. A telephone system in accordance with claim 10 further comprising:
third program means responsive to any given indicated courtesy phone returning across the Internet or comparable network a reply to such an invite request indicating the given courtesy phone is busy for placing said first program means into operation again after a time delay.

12. A telephone system in accordance with claim 10 which further comprises:
fourth means for placing said first program means into operation again a time delay after a two-way voice communications message exchange channel or its equivalent is established by the second means.

13. A telephone system in accordance with claim 11 which further comprises:
third program means responsive to any given indicated courtesy phone returning across the Internet or comparable network a reply to such an invite request indicating the given courtesy phone is busy for placing said first program means into operation again after a time delay.

14. A telephone system in accordance with claim 10:
wherein the operator's phone is one of the VoIP-style phones;
and wherein the second program means further comprises
fifth means for sending at least one invite request to the operator's phone,
sixth means for sending a re-invite request to the given indicated courtesy phone in response to the operator's phone returning a reply in response to the receipt of an invite request indicating the operator's phone has been taken off hook, and
seventh means for sending an acknowledgment response to the operator's phone and to the given indicated courtesy phone to establish a two-way exchange of voice carrying messages between the operator's phone and the given indicated courtesy phone after the indicated courtesy phone acknowledges the re-invite request.

15. A telephone system in accordance with claim 10:
wherein the operator's phone is a conventional phone connected to the Internet or a comparable network by a gateway;
and wherein the second program means further comprises
fifth means for sending at least one invite request to the gateway, the invite request addressed to the operator's phone,
sixth means for sending a re-invite request to the given indicated courtesy phone in response to the gateway signaling that the operator's phone has gone off hook, and
seventh means for sending an acknowledgement response to the operator's phone and to the gateway's port address assigned to the courtesy phone to establish a two-way exchange of voice carrying messages between the operator's phone and the given indicated courtesy phone after the indicated courtesy phone acknowledges the re-invite request.
